(19) United States
(12) Patent Application Publication
(10) Pub. No.: US 2025/0313457 A1
(43) Pub. Date: Oct. 9, 2025

(54) PROCESS DESIGN ENABLING CARBON BYPRODUCT SEPARATION FOR SUSTAINABLE HYDROGEN PRODUCTION IN METHANE PYROLYSIS PROCESS

(71) Applicant: ARAMCO SERVICES COMPANY, Houston, TX (US)

(72) Inventors: Xiaoxing Wang, Richmond, TX (US); Feng Liang, Houston, TX (US); Hung Q. Truong, Cypress, TX (US)

(73) Assignee: ARAMCO SERVICES COMPANY, Houston, TX (US)

(21) Appl. No.: 18/628,550

(22) Filed: Apr. 5, 2024

(51) Int. Cl. C01B 3/26; B01J 6/00; B01J 38/04; C09C 1/52

(52) U.S. Cl. CPC C01B 3/26; B01J 6/008; B01J 38/04; C09C 1/52; C01B 2203/0277; C01B 2203/049; C01B 2203/085; C01B 2203/1017; C01B 2203/1241; C01B 2203/1623; C01B 2203/1633; C01B 2203/1638

(57) ABSTRACT

A system for producing hydrogen including a methane pyrolysis reactor, a solid-gas separator, and a downstream unit. The system includes a hydrogen and nitrogen feed upstream of the reactor that includes a tube reactor, a catalyst, a frit, and a heating mechanism. The system includes a first and second pressure gauge. A process for producing hydrogen including feeding a hydrogen stream to activate a catalyst, feeding a methane feed to a methane pyrolysis reactor, monitoring a differential pressure, feeding a nitrogen stream to purge the catalyst, feeding the methane pyrolysis product stream to a solid-gas separator, recovering the solid carbon byproduct, feeding a gas mixture stream into a downstream unit and recovering the separated hydrogen. A process for producing hydrogen using methane pyrolysis reactors by concurrently operating at least one of the reactors in a reaction mode and at least one of the reactors in a regeneration mode.

### BACKGROUND

Hydrogen is a clean fuel that, when combusted, results in water production. Hydrogen is often produced from steam methane reforming (SMR) with a water-gas shift reactor, producing large quantities of carbon dioxide. Alternatively, catalytic methane pyrolysis produces only solid carbon instead of gaseous carbon dioxide as the byproduct, thus eliminating carbon dioxide emissions.

The increasing focus on catalytic methane pyrolysis has centered around developing an effective catalyst, though the reactor and process design is of utmost importance to implement catalytic methane pyrolysis on an industrial scale. Accordingly, there exists a need for an improved reactor design and process method to conduct methane pyrolysis for sustainable production of clean hydrogen with little to no carbon dioxide emissions and recovery of the solid carbon byproduct.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a methane pyrolysis reactor configured for receiving a methane feed and producing a methane pyrolysis product stream. The methane pyrolysis product stream is fed to a solid-gas separator downstream of the methane pyrolysis reactor, producing a solid carbon byproduct stream and a gas mixture stream. The gas mixture stream is fed to a gas-gas separator downstream of the solid-gas separator, producing a separated hydrogen stream and a separated methane byproduct stream. A hydrogen feed activates the catalyst bed in the methane pyrolysis reactor. A nitrogen feed purges the catalyst bed and transports the solid carbon from the methane pyrolysis reactor to the solid-gas separator. A first pressure gauge is situated upstream of the methane pyrolysis reactor while a second pressure gauge is downstream, allowing monitoring of the differential pressure across the methane pyrolysis reactor. Embodiments disclosed herein relate to a system with a methane pyrolysis reactor including a tube reactor, a catalyst bed within the tube, a frit within the tube to support the catalyst bed, and a heating mechanism coupled to a thermocouple to monitor and control a temperature of a reactor.

In another aspect, embodiments disclosed herein relate to a process for producing hydrogen using methane pyrolysis by feeding a hydrogen stream upstream of a methane pyrolysis reactor to activate a catalyst bed. Methane is fed to the methane pyrolysis reactor, producing a methane pyrolysis product stream including hydrogen, solid carbon, and unreacted methane. A differential pressure across the methane pyrolysis reactor is continuously monitored. A nitrogen stream is fed upstream of the methane pyrolysis reactor based on the differential pressure to purge the catalyst bed and act as a carrier gas to transport the solid carbon to a solid-gas separator. The methane pyrolysis product stream is fed to the solid-gas separator configured for separating the solid carbon from the methane pyrolysis product stream, producing a solid carbon byproduct stream and a gas mixture stream. The solid carbon byproduct stream is recovered while the gas mixture stream is fed into a downstream unit, producing a separated hydrogen stream and a separated methane byproduct stream. The separated hydrogen stream is recovered. Embodiments disclosed herein relate to a process with a methane pyrolysis reactor including a tube reactor, a catalyst bed within the tube, a frit within the tube to support the catalyst bed, and a heating mechanism coupled to a thermocouple to monitor and control a temperature of a reactor.

In another aspect, embodiments disclosed herein relate to a process for producing hydrogen using a plurality of methane pyrolysis reactors by concurrently operating at least one of the methane pyrolysis reactors in a reaction mode and operating at least one of the methane pyrolysis reactors in a regeneration mode. Concurrently operating and regenerating includes feeding a hydrogen stream to a first methane pyrolysis reactor to activate a first catalyst bed. A reactor gas feed is fed to the first methane pyrolysis reactor to produce a first methane pyrolysis product stream including hydrogen, solid carbon, and unreacted methane. A differential pressure across the first methane pyrolysis reactor is continuously monitored. A nitrogen stream is fed upstream of the first methane pyrolysis reactor to purge the first catalyst bed and act as a carrier gas to transport the solid carbon to a first solid-gas separator. A second hydrogen stream is then fed upstream of a second methane pyrolysis reactor to activate a second catalyst bed. The reactor gas feed is fed to a second methane pyrolysis reactor to produce a second methane pyrolysis product stream including hydrogen, solid carbon, and unreacted methane. Differential pressure is monitored across the second methane pyrolysis reactor. The nitrogen stream is fed to the second methane pyrolysis reactor to purge the second catalyst bed and act as a carrier gas to transport the solid carbon to a second solid-gas separator. The first catalyst bed is regenerated when it is spent and the second catalyst bed is also regenerated when it is spent. The two reactors may be operated in such a way that when the first methane pyrolysis reactor is in a regeneration mode, the second methane pyrolysis reactor is in a reaction mode for methane pyrolysis to produce hydrogen, solid carbon, and unreacted methane. Further, the two reactors may be operated in such a way that when the first methane pyrolysis reactor is in a reaction mode while the second methane pyrolysis reactor is in a regeneration mode. Alternatively, both the first methane pyrolysis reactor and the second methane pyrolysis reactor may be in a reaction mode simultaneously or in a regeneration mode simultaneously. Effluent lines exiting the first methane pyrolysis reactor and the second methane pyrolysis reactor are separated by a four-way valve ensuring that the product from the reaction mode is not combined with an effluent from the regeneration mode. The first methane pyrolysis product stream is individually fed to a first solid-gas separator configured for separating the solid carbon from the first methane pyrolysis product stream, producing a first solid carbon byproduct stream and a first gas mixture stream. The second methane pyrolysis product stream is fed to a second solid-gas separator configured for separating the solid carbon from the second methane pyrolysis product stream, producing a second solid carbon byproduct stream and a second gas mixture stream. Each of the solid carbon byproduct streams is recovered and each of the gas mixture streams is fed into separate downstream units to produce separated hydrogen streams and separated methane byproduct streams. The separated hydrogen streams are recovered.

Other aspects and advantages of the claimed subject matter will be apparent from the following description and the appended claims.

### BRIEF DESCRIPTION OF DRAWINGS

FIG. 1 is an overall schematic of a system in accordance with one or more embodiments.

FIG. 2 is a detailed diagram of a catalytic methane pyrolysis system in accordance with one or more embodiments.

FIG. 3 is an illustration of a straight tube reactor in accordance with one or more embodiments.

FIG. 4 is an illustration of a spear-shaped tube reactor in accordance with one or more embodiments.

FIG. 5 is an illustration of two tube reactors configured in parallel in accordance with one or more embodiments.

FIG. 6 is a detailed diagram of a catalytic methane pyrolysis system with a branched separator in accordance with one or more embodiments.

### DETAILED DESCRIPTION

In one aspect, embodiments disclosed herein relate to a system for producing hydrogen using a methane pyrolysis process. In another aspect, embodiments disclosed herein relate to a method for producing hydrogen using a methane pyrolysis process. Embodiments disclosed herein relate to methane feeds that may include biogas, natural gas, or may be sourced from natural gas. The methane gas feeds may include a variety of other components including ethane, propane, butane, pentane, nitrogen, carbon dioxide, oxygen, hydrogen, and other hydrocarbons. Embodiments disclosed herein relate to using a particular tube reactor design to effectively produce hydrogen and a solid carbon byproduct from the methane feed, where the solid carbon byproduct is separated for storage or other uses.

Methane is fed to a methane pyrolysis reactor, producing hydrogen with solid carbon and residual natural gas as a byproduct. The solid carbon is recovered using a solid-gas separator, allowing for potential solid carbon storage. The remaining product stream includes hydrogen and residual methane, including other components in the methane feed as described above, as a byproduct. The residual methane may be separated in a downstream unit and recycled to combine with the methane feed. The separated hydrogen stream is recovered and may be stored.

The system may include multiple gas feed lines combining to form the reactor feed gas line. These multiple gas feed lines may include feeds for nitrogen, methane, carbon dioxide, and hydrogen. The flow rates may be controlled to provide a control method for optimizing system performance. The reactor feed gas line may include a pressure relief valve and pressure gauge upstream and a pressure gauge downstream of the methane pyrolysis reactor to monitor the differential pressure across the methane pyrolysis reactor.

The methane pyrolysis reactor may include one or more tube reactors. In one or more embodiments, the tube of the methane pyrolysis reactor may be constructed of quartz, alumina, or carbon-resistant stainless steel. The methane pyrolysis reactor includes a frit, designed to support a catalyst bed. The frit may be a circular disk made of a ceramic material. The diameter of the frit will vary based on the diameter of the tube of the methane pyrolysis reactor. The methane pyrolysis reactor includes a heating mechanism coupled to one or more thermocouples and one or more temperature controllers to ensure proper reactor temperature. In one or more embodiments, the methane pyrolysis reactor temperature falls in the range of 500 to 900° C. In one or more embodiments, this heating mechanism is an electric furnace. In other embodiments, the electric furnace may be replaced by a microwave adsorption material and a microwave generator to offer an efficient and uniform alternative heating mechanism for the reactor and the catalyst.

The methane pyrolysis product stream from the methane pyrolysis reactor may flow through a flow line, containing a pressure gauge, to a solid-gas separator to remove the solid carbon from the product stream and produce a gas mixture. In one or more embodiments, a carbon byproduct separator and collector may branch directly off of the methane pyrolysis reactor.

In one or more embodiments, the gas mixture, containing hydrogen and residual methane, may be further separated in a downstream unit. In one or more embodiments, the downstream unit is a gas-gas separator to purify the hydrogen and recycle the residual methane. In other embodiments, the gas mixture may flow through a particulate filter and a flowmeter to provide a proper feed to the downstream unit. In one or more embodiments, the downstream unit may include analytical equipment such as a gas chromatography thermal conductivity detector (GC-TCD) or a mass spectrometer that will separate and analyze the gas mixture.

Catalysts for use in the methane pyrolysis reactor may include iron-based catalysts, cobalt-based catalysts, or nickel-based metal catalysts. The catalyst may include one or more of iron, cobalt, and nickel on a catalyst support. The catalyst may be a carbon catalyst. Catalysts may include one or more of high entropy alloy catalysts and medium entropy alloy catalysts. The high entropy alloy catalysts may include one or more of unsupported high entropy alloy catalysts and supported high entropy alloy catalysts. The medium entropy alloy catalysts may include one or more of unsupported medium entropy alloy catalysts and supported medium entropy alloy catalysts.

High entropy alloy (HEA) refers to a catalytic composition that has a mixed configuration entropy of greater than or equal to 12.47 J*K⁻¹*mol⁻¹ and/or a catalytic composition comprising a metal alloy whose composition consists of five or more metal elements, with each element having a concentration from 0.1 atomic percent (at %) to 50 at %. Examples of high entropy alloys that are suitable for use in catalysts may include Co, Cr, Fe, Mn, Ni, Al, Mo, Cu, Zn, Zr, Ru, Rh, Pd, Ag, W, Re, Ir, Pt, Au, Ce, Yb, Sn, the like, or any combination thereof. Each metal in the high entropy alloy may be present at varying atomic percentages. These catalysts may further include a secondary phase including an intermetallic phase, a laves phase, a carbide phase, a boride phase, a boron-carbide phase, a nitride phase, a silicide phase, an aluminide phase, an oxide phase (e.g., MgO, Al₂O₃, or any combination thereof), a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

Medium entropy alloy (HEA) refers to a catalytic composition having a configuration entropy larger than 1.5*R, whereas the medium entropy alloy has a configuration entropy between 1*R and 1.5*R, where R is the universal gas constant. Medium entropy alloy (MEA) catalysts may include one or more MEA particles including three or four principal metals at varying atomic percentages. The principal metals can be independently selected from the group consisting of Co, Cr, Fe, Mn, Mo, Ti, V, Y, Ga, In, Ni, Al, Cu, Zn, Zr, Ru, Rh, Pd, Ag, W, Re, Ir, Pt, Au, Ce, Yb, Sn, Ca, and Be. In one or more embodiments, an MEA particle includes a first principal metal, where the first principal metal is Fe, a second principal metal, where the second principal metal is Mn. These catalysts may also further include a secondary phase including an intermetallic phase, a laves phase, a carbide phase, a boride phase, a boron-carbide phase, a nitride phase, a silicide phase, an aluminide phase, an oxide phase (e.g., MgO, Al₂O₃, or any combination thereof), a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof. These catalysts may include promoters that may improve the activity of the catalyst. Useful promotors may include Mb, Ca, Cs, high melting oxides including Al, Cr, rare earth elements, chlorides of alkali metals, carbide, borides, boron carbides, nitrides, boron nitrides, silicide, aluminides, oxides, phosphides, phosphates, sulfides, sulfates, hydrides, hydrates, carbonitrides, graphene, graphene oxide, nanotubes, graphite, and non-reducible metal oxides including, but not limited to, Li₂O, K₂O, Na₂O, Cs₂O, BeO, MgO, CaO, SrO, BaO, P₂O₅, Al₂O₃, Al₂O₄, SiO₂, TiO₂, ZrO₂, CeO₂, Y₂O₃, lanthanide oxides (e.g., La₂O₃, Er₂O₃). Non-reducible oxides, chlorides, and other non-reducible stable compounds may be used as co-promotors.

Supported catalysts may include a catalyst support such as a metal, a metal oxide, mixed oxide, carbon material, metal organic framework (MOF), a zeolite, carbon black, a secondary phase, the like, or any combination thereof. Suitable metal oxides may include Al₂O₃, SiO₂, MgO, TiO₂, Fe₃O₄, Fe₂O₃, ZrO₂, CeO₂, a lanthanide oxide (e.g., Er₂O₃), the like, or any combination thereof. The catalyst support may be an internal catalyst support, an external catalyst support, or any combination thereof. An “internal catalyst support” as used herein refers to the catalyst support being embedded in the high or medium entropy alloy structure. An “external catalyst support” as used herein refers to a catalyst support that is external to the structure of the high or medium entropy alloy.

The catalyst in the methane pyrolysis reactor may be subjected to one or more of activation, purging, and regeneration to maintain activity. To activate the catalyst initially, hydrogen is provided to the methane pyrolysis reactor as a pre-treatment through the reactor feed gas line. After the catalyst is activated, methane may be fed to operate the system. Throughout operation, the catalyst bed may undergo purging, as is indicated by differential pressure across the methane pyrolysis reactor, to dislodge solid carbon build up on the catalyst using nitrogen fed through the reactor feed gas line, ultimately prolonging the life of the catalyst. The nitrogen may be fed instead through a catalyst treatment line upstream of the methane pyrolysis reactor. In one or more embodiments, a differential pressure at a predetermined value may prompt purging. The predetermined value may be from 25 to 35 psig, for example 30 psig. This nitrogen stream also serves as a carrier gas to transport the solid carbon downstream to a solid-gas separator. Once the catalyst is spent, the catalyst may be regenerated to maintain activity. The methane conversion rate indicates when regeneration is required. In one or more embodiments, a conversion rate below 50% may prompt regeneration. In other embodiments, carbon dioxide may be used to regenerate the catalyst, reacting with carbon to produce carbon monoxide, which is a fuel and a feedstock for other chemical reactions. In one or more embodiments, the regeneration may be conducted ex situ, where acid may be used to remove carbon from the catalyst. In embodiments using an iron-based metal alloy catalyst, a magnet may be used to recover the metal catalyst from the carbon. When the regeneration is conducted in situ, the carbon dioxide may be injected through the reactor feed gas line, the catalyst treatment line, or a dedicated carbon dioxide line upstream of the methane pyrolysis reactor.

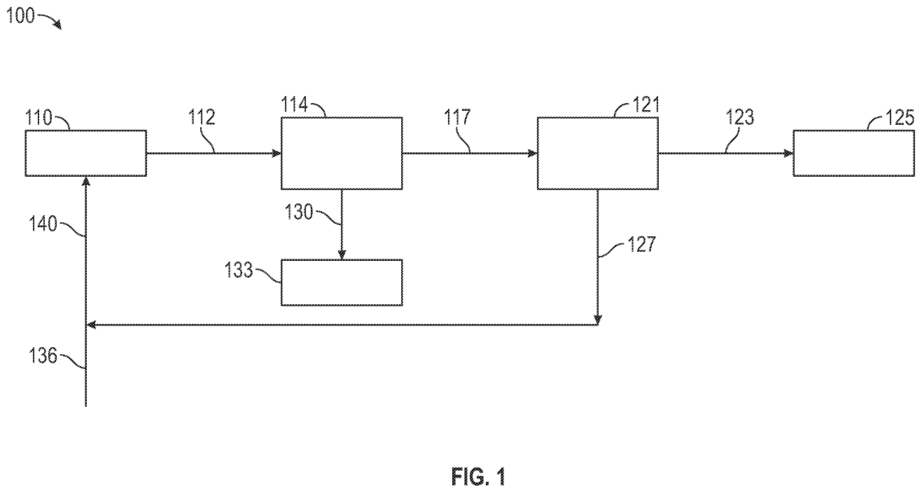

FIG. 1 is an overall schematic of a system for hydrogen production from methane using methane pyrolysis. A methane feed 136 is fed into the hydrogen production system 100. The methane feed 136 combines with a separated methane byproduct stream 127 recycled back into a reactor feed gas line 140. Following a reaction within the methane pyrolysis reactor 110, a methane pyrolysis product stream 112 exits the methane pyrolysis reactor 110. The methane pyrolysis product stream 112 includes hydrogen, carbon, and unreacted methane, with the carbon in a solid state. The methane pyrolysis product stream 112 is fed into a solid-gas separator 114. The solid-gas separator 114 produces a solid carbon byproduct stream 130 and a gas mixture stream 117. The solid carbon byproduct stream 130 is stored in a carbon storage chamber 133. The gas mixture stream 117 is fed into a downstream unit. In FIG. 1, the downstream unit is a gas-gas separator 121, producing a separated hydrogen stream 123 and a separated methane byproduct stream 127. In one or more embodiments, the gas-gas separator may utilize a membrane system to selectively separate and purify hydrogen. The separated hydrogen stream 123 may be stored in a hydrogen storage vessel 125. In one or more embodiments, hydrogen may be stored in a container, such as a tank or a compressed cylinder. In other embodiments, hydrogen may be directed piped to an end user. The separated methane byproduct stream 127 combines with the methane feed 136 in the reactor gas feed line 140.

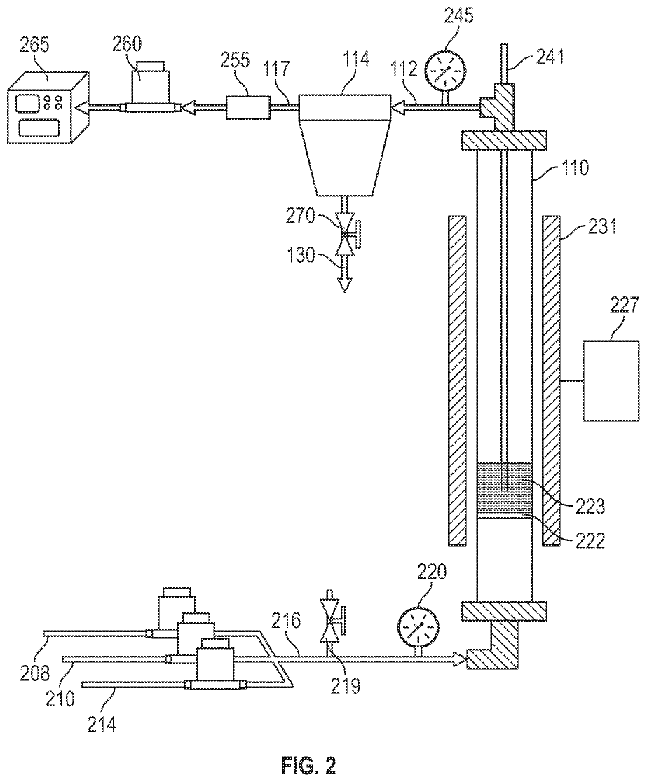

FIG. 2 is a detailed diagram of a catalytic methane pyrolysis system. A nitrogen feed 208 combines with a methane feed 210 and a hydrogen feed 214 in the reactor feed gas line 216. The nitrogen feed 208 purges the reactor system and acts as a carrier gas to transport the solid carbon generated in the methane pyrolysis reactor 110 to the solid-gas separator 114. The hydrogen feed 214 activates the catalyst in the methane pyrolysis reactor 110. The flow rate of each of the feeds is controlled by a mass flow controller. There is a pressure relief valve 219 coupled to a first pressure gauge 220 in the reactor feed gas line 216, which flows the feed gas to the methane pyrolysis reactor 110.

As illustrated in FIG. 2, the methane pyrolysis reactor 110 includes a frit 222 to support the catalyst bed 223. An electric furnace 231 heats the methane pyrolysis reactor 110. The temperature of the methane pyrolysis reactor 110 is measured by a thermocouple 241. The temperature measurements of the thermocouple 241 are monitored by the temperature controller 227, which in turn adjusts the electric furnace 231 to a desired temperature based on the temperature measurements.

The methane pyrolysis reactor 110 receives methane through the reactor feed gas line 216, producing the methane pyrolysis product stream 112. There is a second pressure gauge 245 monitoring the flow line for the methane pyrolysis product stream 112. The methane pyrolysis product stream 112 is fed to the solid-gas separator 114, producing the solid carbon byproduct stream 130 and the gas mixture stream 117. There is a valve 270 disposed in the flow line for the solid carbon byproduct stream 130. In one or more embodiments, as illustrated in FIG. 2, the gas mixture stream 117 flows through a particulate filter 255 and a flow meter 260. The particulate filter 255 removes potential solid carbon powder particle contamination from the gas mixture stream 117 to protect the downstream unit 265. The downstream unit 265 may be a gas-gas separator. In testing, the downstream unit 265 may be a gas chromatography thermal conductivity detector (GC-TCD), or a mass spectrometer. In embodiments using a gas-gas separator, a particulate filter 255 and a flow meter 260 may or may not be present downstream of the solid-gas separator 114. The flow meter 260 measures the flow rate of the gas mixture stream 117. The data from the flow meter 260 may be tracked and stored. This stored data may be used to calculate hydrogen production rate or methane conversion rates to optimize system parameters and performance. When a gas-gas separator is used, the separated methane may be recycled to combine with the methane feed 210 (as shown in FIG. 1, 127).

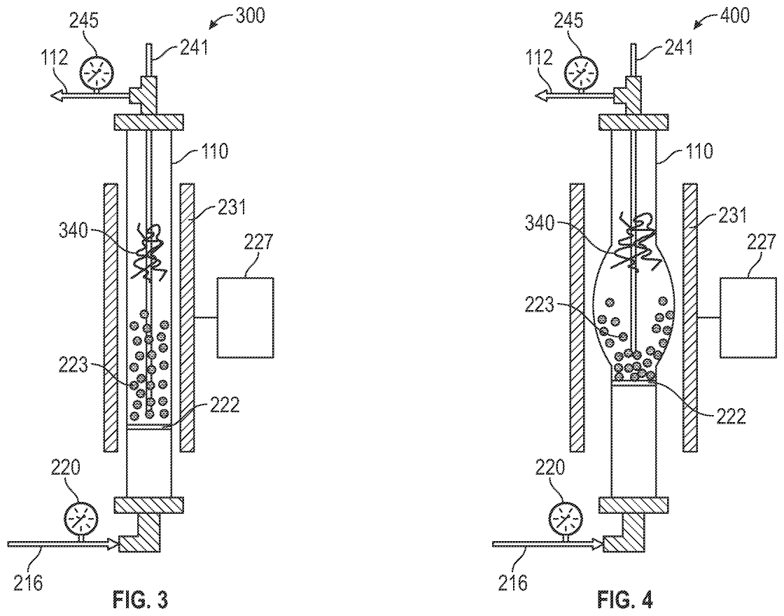

The methane pyrolysis reactor 110 may be a straight tube reactor or a spear-shaped tube reactor. A straight tube reactor 300 is illustrated in FIG. 3. There is a first pressure gauge 220 in the reactor feed gas line 216 to the methane pyrolysis reactor 110. The straight tube reactor 300 includes a frit 222 to support the catalyst bed 223. The carbon 340 is above the catalyst bed 223. The catalyst bed 223 may be fluidized rather than packed in a dense arrangement. The shape of the walls of the reactor is linear, or straight, from the inlet to the outlet of the methane pyrolysis reactor 110. The methane pyrolysis reactor 110 includes a temperature controller 227 communicating with the thermocouple 241. The temperature controller 227 adjusts the electric furnace 231 to achieve a desired temperature in the methane pyrolysis reactor 110, measured by the thermocouple 241. There is a second pressure gauge 245 monitoring the flow line for the methane pyrolysis product stream 112.

The methane pyrolysis reactor 110 may be a spear-shaped tube reactor. A spear-shaped tube reactor 400 is illustrated in FIG. 4. There is a first pressure gauge 220 in the reactor feed gas line 216 to the methane pyrolysis reactor 110. The straight tube reactor 300 includes a frit 222 to support the catalyst bed 223. The carbon 340 is above the catalyst bed 223. The walls of the reactor are rounded, with a larger diameter than the inlet and outlet of the methane pyrolysis reactor 110, as shown. The spear-shaped reactor design facilitates the fluidization of the catalyst particles and ensures the solid carbon dislodges from the catalyst bed 223. The methane pyrolysis reactor 110 includes a temperature controller 227 communicating with the thermocouple 241. The temperature controller 227 adjusts the electric furnace 231 to achieve a desired temperature in the methane pyrolysis reactor 110, measured by the thermocouple 241. There is a second pressure gauge 245 monitoring the flow line for the methane pyrolysis product stream 112.

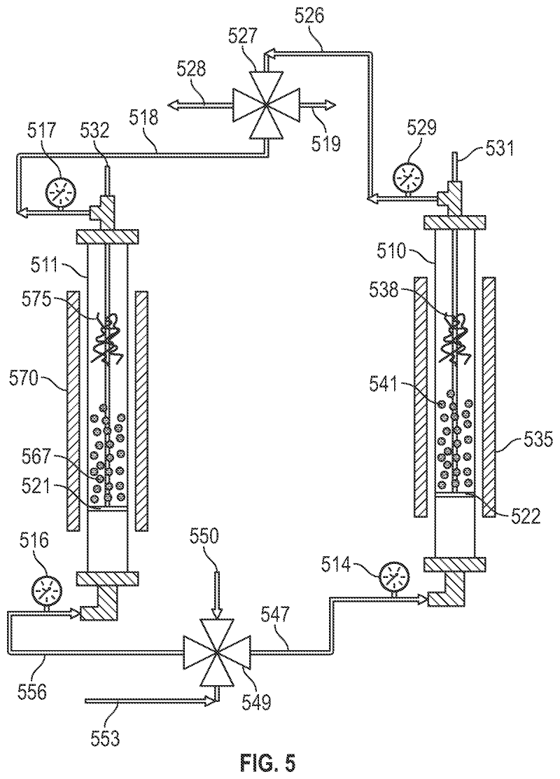

Some configurations may utilize a plurality of methane pyrolysis reactors. In one or more embodiments, two tube reactors configured in parallel, as shown in FIG. 5. In the parallel configuration, one of the methane pyrolysis reactors may be concurrently under a reaction mode while the other methane pyrolysis reactor is under a catalyst regeneration mode, or both methane pyrolysis reactors may be in a reaction mode simultaneously. The alternating operation will allow for alternating between the two methane pyrolysis reactors continually, eliminating downtime for catalyst regeneration. In FIG. 5, the methane feed 553 and the catalyst treatment feed 550 are introduced separately via a first four-way valve 549 to form two parallel lines including a first reactor gas feed 547 and a second reactor gas feed 556. The methane feed 553 may flow methane through the first reactor gas feed 547 while nitrogen flows through the catalyst treatment feed 550 through the second reactor gas feed 556. The first reactor gas feed 547 contains a first feed line pressure gauge 514. The nitrogen flow dislodges the first carbon from the catalyst in the second methane pyrolysis reactor 511, and may be followed by a carbon dioxide flow through the same line to regenerate the second catalyst bed 567. In this embodiment, the first methane pyrolysis reactor 510 is in a reaction mode while the second methane pyrolysis reactor 511 is in a regeneration mode. In other embodiments, the methane feed 553 may flow methane through the second reactor gas feed 556 while nitrogen flows through the catalyst treatment feed 550 through the first reactor gas feed 547. The second reactor gas feed 556 contains a second feed line pressure gauge 516. The nitrogen flow dislodges the second carbon from the catalyst in the first methane pyrolysis reactor 510, and may be followed by a carbon dioxide flow through the same line to regenerate the first catalyst bed 541. In this embodiment, the first methane pyrolysis reactor 510 is in a regeneration mode while the second methane pyrolysis reactor 511 is in a reaction mode.

The first methane pyrolysis reactor 510 includes a frit 522 to support the first catalyst bed 541 and first carbon 538. The first methane pyrolysis reactor 510 includes a first thermocouple 531 and a first electric furnace 535. The second methane pyrolysis reactor 511 is configured similarly, containing a frit 521 to support the second catalyst bed 567 with second carbon 575. The second methane pyrolysis reactor 511 includes a second thermocouple 532 and a second electric furnace 570.

FIG. 5 illustrates the embodiment where the first methane pyrolysis reactor 510 is in a reactor mode while the second methane pyrolysis reactor 511 is in a regeneration mode. The first methane pyrolysis reactor 510 is in a reaction mode, and thus the first methane pyrolysis reactor 510 produces a first methane pyrolysis product stream 526 containing a first methane pyrolysis product pressure gauge 529 in the line. The second methane pyrolysis reactor 511 is fed nitrogen and subsequently carbon dioxide in a regeneration mode dislodging the second carbon 575 from the second catalyst bed 567 and regenerating the second catalyst bed 567, producing a regeneration gas stream 518. The first methane pyrolysis product stream 526 and the regeneration gas stream 518 flow through a second four-way valve 527 directing each stream separately in different flow paths. As shown in FIG. 5, the first methane pyrolysis product stream 526 is directed through the second four-way valve 527 as a downstream first methane pyrolysis product stream 528. The regeneration gas stream 518 is directed through the second four-way valve 527 as a downstream regeneration gas stream 519. It will be understood that in one or more embodiments (not shown) both of the methane pyrolysis reactors may be in a reaction mode or the second methane pyrolysis reactor 511 may be in a reaction mode while the first methane pyrolysis reactor 510 may be in a regeneration mode, a second methane pyrolysis product pressure gauge 517 exists in the line where the regeneration gas stream 518 is flowing out of the second methane pyrolysis reactor 511. It will be understood that in one or more embodiments (not shown), the separate methane pyrolysis product stream and regeneration gas stream may flow out of the second four-way valve 527 to downstream system components including a solid-gas separator and a downstream unit such as a gas-gas separator, as is illustrated in FIG. 1.

In one or more embodiments, the methane pyrolysis reactor 110 may be two tube reactors in series. In this configuration (not shown), the first tube reactor will react the methane. When the catalyst of the first tube reactor is saturated, requiring regeneration, the saturated catalyst is transferred to the second tube reactor for regeneration. Specifically, the catalyst is lowered from the top of the first tube reactor to the bottom while the methane flows from the bottom of the tube reactor to the top of the tube reactor, increasing contact time between the catalyst and the methane. The catalyst collected at the bottom of the first tube reactor is conveyed to the second tube reactor for regeneration. The flow rate and temperature of the regeneration gas are controlled during regeneration. The first and second tube reactors are interconnected at the top of the second tube reactor. The regeneration gas flow carries the catalyst particles from the bottom to the top of the second tube reactor, leading the regenerated catalyst particles back into the first tube reactor. The catalyst can be circulated between the two tube reactors in this way.

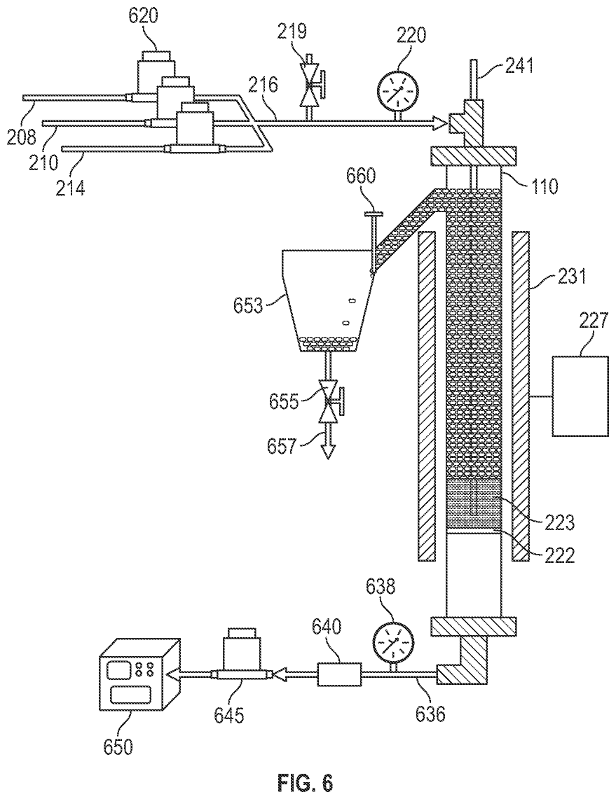

As shown in FIG. 6, a straight tube reactor may be used for the methane pyrolysis reactor 110 with a carbon byproduct separator and collector 653 branching directly off of the methane pyrolysis reactor 110. In FIG. 6, the branch is in the center of the methane pyrolysis reactor 110, though it will be understood that in one more embodiments (not shown), the branch may be in different locations of the methane pyrolysis reactor 110 such as the top or in the flow line exiting the methane pyrolysis reactor 110. In FIG. 6, the methane flows from the top of the methane pyrolysis reactor 110 towards the bottom, near the catalyst bed 223. As methane passes through the catalyst bed 223, carbon accumulates on the surface of the catalyst bed 223. When the accumulated carbon reaches the branch port to the carbon byproduct separator and collector 653, the solid carbon collects into the carbon byproduct separator and collector 653. There may be a carbon byproduct valve 660 to prevent gases from entering into the carbon byproduct separator and collector 653. The carbon byproduct valve 660 may be opened or closed during operation. A nitrogen feed 208 combines with a methane feed 210 and a hydrogen feed 214 in the reactor gas feed line 216. The nitrogen feed 208 purges the reactor system and acts as a carrier gas to transport the solid carbon generated in the methane pyrolysis reactor 110 to the carbon byproduct separator and collector 653. The hydrogen feed 214 activates the catalyst in the methane pyrolysis reactor 110. The flow rate of each of the feeds is controlled by a mass flow controller 620. There is a pressure relief valve 219 coupled to a first pressure gauge 220 in the reactor feed gas line 216. The methane flows through the reactor feed gas line 216 to the methane pyrolysis reactor 110.

In FIG. 6, the methane pyrolysis reactor 110 includes a frit 222 to support the catalyst bed 223. An electric furnace 231 heats the methane pyrolysis reactor 110. The temperature of the methane pyrolysis reactor 110 is measured by a thermocouple 241. The temperature measurements of the thermocouple 241 are monitored by the temperature controller 227, which in turn adjusts the electric furnace 231 to a desired temperature.

The reactor feed gas line 216 directs methane to the methane pyrolysis reactor 110, producing a methane pyrolysis product that is separated into a solid carbon byproduct stream 657 and a gas mixture stream 636. There is a pressure gauge 638 monitoring the flow line for the gas mixture stream 636. The methane pyrolysis product flows to the carbon byproduct separator and collector 653, removing the solid carbon byproduct stream 657, resulting in a gas mixture stream 636. There is a valve 655 disposed in the flow line for the solid carbon byproduct stream 657. The gas mixture stream 636 flows through a particulate filter 640 and a flow meter 645. The particulate filter 640 removes potential solid carbon powder particle contamination from the gas mixture stream 636 to protect the downstream unit 650. The flow meter 645 measures the flow rate of the gas mixture stream 636. The data from the flow meter 645 may be tracked and stored. This stored data may be used to calculate hydrogen production rate or methane conversion rates to optimize system parameters and performance. The downstream unit 650 may include a gas chromatography thermal conductivity detector (GC-TCD) or a mass spectrometer. In one or more embodiments, a gas-gas separator (as shown in FIG. 1, 121) may purify the hydrogen in the gas mixture stream 636, producing a separated methane byproduct stream and a separated hydrogen stream. In these embodiments, a particulate filter 640 and a flow meter 645 may or may not be present. In these embodiments, the separated methane byproduct stream (as shown in FIG. 1, 127) may be recycled to combine with the methane feed 210.

### Example

The system and process were demonstrated through testing. The general procedure was as follows. A metal-based catalyst was loaded into a tube reactor. Nitrogen was purged (20 mL/minute) to remove air in the reactor environment. The furnace heating the tube reactor was initiated to the desired temperature (700° C.) at a rate of increase of 10-20° C./minute. The hydrogen gas was provided to the system at a flowrate of 20 mL/minute to perform the catalyst pre-treatment. The temperature of the reactor was adjusted under hydrogen flow to maintain the desired temperature (700° C.). Methane was introduced at a flowrate of 20 mL/minute to start the reaction. The pressure drop of the reactor system was monitored. The downstream unit was a gas chromatography thermal conductivity detector (GC-TCD), which monitored methane conversion and hydrogen production during the process.

Testing results showed a visible catalyst bed, carbon, and a zirconium dioxide media in a methane pyrolysis tube reactor, using a quartz tube reactor. The catalyst was initially placed just above the zirconium dioxide media in the methane pyrolysis tube reactor, though it moved upwards within the tube reactor during operation. The space between the zirconium dioxide media contained solid carbon generated from the reaction, growing from the catalyst interface. The natural gas feed was injected from the bottom of the reactor. The results shown indicate that the direction of carbon accumulation is opposite that of the direction of natural gas flow.

Embodiments of the present disclosure may provide at least one of the following advantages. The process provides a method of producing hydrogen with solid carbon byproduct rather than undesirable carbon dioxide emissions. Solid carbon is a valuable byproduct that may be utilized or sold. This approach to reactor design in methane pyrolysis processes address the issues associated with catalyst deactivation and regeneration at large scales, as processes using fixed-bed reactors struggle with pressure drop due to carbon deposition that eventually blocks the reactor.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for producing hydrogen using methane pyrolysis, comprising:
a methane pyrolysis reactor configured for receiving a methane feed and producing a methane pyrolysis product stream;
a solid-gas separator downstream of the methane pyrolysis reactor configured for receiving the methane pyrolysis product stream and producing a solid carbon byproduct stream and a gas mixture stream;
a downstream unit downstream of the solid-gas separator configured for receiving the gas mixture stream;
a hydrogen feed upstream of the methane pyrolysis reactor for activating a catalyst bed;
a nitrogen feed upstream of the methane pyrolysis reactor for purging the catalyst bed and transporting solid carbon to the solid-gas separator; and
a first pressure gauge upstream of the methane pyrolysis reactor and a second pressure gauge downstream of the methane pyrolysis reactor configured for monitoring a differential pressure across the methane pyrolysis reactor;
wherein the methane pyrolysis reactor comprises:
a tube reactor;
the catalyst bed within the tube reactor;
a frit within the tube reactor to support the catalyst bed; and
a heating mechanism coupled to a thermocouple configured to monitor and control a reactor temperature.

2. The system of claim 1, wherein the tube reactor is straight.

3. The system of claim 1, wherein the tube reactor is spear-shaped.

4. The system of claim 1, wherein the tube reactor is constructed of materials selected from the group consisting of quartz, alumina, and carbon-resistant stainless steel.

5. The system of claim 1, wherein the catalyst bed comprises a catalyst selected from the group consisting of iron-based catalysts, cobalt-based catalysts, nickel-based catalysts, and carbon catalysts.

6. The system of claim 1, wherein the catalyst bed comprises a catalyst selected from the group consisting of high entropy alloy catalysts, medium entropy alloy catalysts, and combinations thereof.

7. The system of claim 1, wherein the heating mechanism is an electric furnace.

8. The system of claim 1, wherein the heating mechanism is a microwave generator.

9. The system of claim 1, further comprising a second methane pyrolysis reactor in a parallel arrangement to the methane pyrolysis reactor, configured for receiving a second reactor gas feed and producing a second methane pyrolysis product stream.

10. The system of claim 1, wherein the solid-gas separator is configured for producing a separated hydrogen stream and a separated methane byproduct stream.

11. The system of claim 9, further comprising:
a parallel flow line first pressure gauge upstream of the second methane pyrolysis reactor; and
a parallel flow line second pressure gauge downstream of the second methane pyrolysis reactor;
wherein the parallel flow line first pressure gauge and the parallel flow line second pressure gauge are used for monitoring a differential pressure across the second methane pyrolysis reactor.

12. A process for producing hydrogen using methane pyrolysis, comprising:
feeding a hydrogen stream upstream of a methane pyrolysis reactor to activate a catalyst bed;
feeding a methane feed to the methane pyrolysis reactor, producing a methane pyrolysis product stream including hydrogen, solid carbon, and unreacted methane, wherein the methane pyrolysis reactor comprises:
a tube reactor;
the catalyst bed within the tube reactor;
a frit within the tube reactor to support the catalyst bed; and
a heating mechanism coupled to a thermocouple configured to monitor and control a reactor temperature;
continuously monitoring a differential pressure across the methane pyrolysis reactor;
feeding a nitrogen stream upstream of the methane pyrolysis reactor based on the differential pressure to purge the catalyst bed and act as a carrier gas to transport the solid carbon to a solid-gas separator;
feeding the methane pyrolysis product stream to the solid-gas separator configured for separating the solid carbon from the methane pyrolysis product stream, producing a solid carbon byproduct stream and a gas mixture stream;
recovering the solid carbon byproduct stream;
feeding the gas mixture stream into a downstream unit; and
recovering a separated hydrogen stream.

13. The process of claim 12, further comprising adjusting a temperature of an electric furnace based on a temperature in the methane pyrolysis reactor to achieve a desired temperature.

14. The process of claim 12, further comprising producing the separated hydrogen stream and a separated methane byproduct stream in the downstream unit.

15. The process of claim 12, further comprising regenerating the catalyst bed in situ by feeding a carbon dioxide stream to the methane pyrolysis reactor.

16. The process of claim 12, further comprising regenerating the catalyst bed ex situ using an acid.

17. The process of claim 12, further comprising regenerating the catalyst bed ex situ using a magnet.

18. A process for producing hydrogen using a plurality of methane pyrolysis reactors, comprising:
concurrently operating at least one of the plurality of methane pyrolysis reactors in a reaction mode and at least one of the plurality of methane pyrolysis reactors in a regeneration mode, wherein the currently operating comprises:
operating a first methane pyrolysis reactor in the reaction mode, comprising:
feeding a first hydrogen stream upstream of a first methane pyrolysis reactor to activate a first catalyst bed;
feeding a reactor gas feed to the first methane pyrolysis reactor configured for producing a first methane pyrolysis product stream including hydrogen, solid carbon, and unreacted methane;
continuously monitoring a differential pressure across the first methane pyrolysis reactor;
feeding a nitrogen stream upstream of the first methane pyrolysis reactor to purge the first catalyst bed and act as a carrier gas to transport carbon derived from the first catalyst bed to a first solid-gas separator;
feeding the first methane pyrolysis product stream to the first solid-gas separator configured for separating the carbon derived from the first catalyst bed from the first methane pyrolysis product stream, producing a first solid carbon byproduct stream and a first gas mixture stream;
recovering the first solid carbon byproduct stream;
feeding the first gas mixture stream into a first downstream unit, producing a first separated hydrogen stream and a first separated methane byproduct stream; and
recovering the first separated hydrogen stream;
regenerating the first methane pyrolysis reactor when the first catalyst bed is spent;
operating a second methane pyrolysis reactor in the reaction mode, comprising:
feeding a second hydrogen stream upstream of a second methane pyrolysis reactor to activate a second catalyst bed;
feeding the reactor gas feed to a second methane pyrolysis reactor configured for producing a second methane pyrolysis product stream including hydrogen, solid carbon, and unreacted methane;
continuously monitoring a differential pressure across the second methane pyrolysis reactor;
feeding the nitrogen stream upstream of the second methane pyrolysis reactor to purge the second catalyst bed and act as a carrier gas to transport carbon derived from the second catalyst bed to a second solid-gas separator;
feeding the second methane pyrolysis product stream to the second solid-gas separator configured for separating the carbon derived from the second catalyst bed from the second methane pyrolysis product stream, producing a second solid carbon byproduct stream and a second gas mixture stream;
recovering the second solid carbon byproduct stream;
feeding the second gas mixture stream into a second downstream unit, producing a second separated hydrogen stream and a second separated methane byproduct stream; and
recovering the second separated hydrogen stream; and
regenerating the second methane pyrolysis reactor when the second catalyst bed is spent.

19. The process of claim 18, wherein regenerating comprises feeding a carbon dioxide stream upstream of the first methane pyrolysis reactor and the second methane pyrolysis reactor.

20. The process of claim 18, wherein regenerating comprises removal of a catalyst from one or more of the first catalyst bed and the second catalyst bed for regeneration ex situ.

21. The process of claim 18, wherein regenerating comprises using a magnet to recover a catalyst from one or more of the first catalyst bed and the second catalyst bed.

22. The process of claim 18, further comprising adjusting a temperature of an electric furnace based on a temperature in each of the plurality of methane pyrolysis reactors to achieve a desired temperature.
